(19) United States
(12) Patent Application Publication
(10) Pub. No.: US 2025/0291949 A1
(43) Pub. Date: Sep. 18, 2025

(54) SYSTEM AND METHOD FOR GENERATION AND USE OF COPY-PROTECTED FILES IN SECURE TRANSACTIONS

(71) Applicant: Andrey Rogachev, Paudex (CH)

(72) Inventor: Andrey Rogachev, Paudex (CH)

(21) Appl. No.: 18/605,011

(22) Filed: Mar. 14, 2024

(51) Int. Cl. G06F 21/62; G06Q 20/38

(52) U.S. Cl. CPC G06F 21/6245; G06Q 20/389

(57) ABSTRACT

Systems and methods for transactions using digital currency based on copy-protected files are disclosed. An issuer transfers digital currency to a secure wallet in the form of a digital pocket on a hardware device. The device user transfers digital currency offline and transactions are validated and synchronized both locally and by the issuer from a central server. A dedicated file type, file system, and communications protocol are used to create the ecosystem for transitions using the digital pocket.

### TECHNICAL FIELD

The present disclosure generally relates to a digital ecosystem for secure transactions. More particularly, the disclosure relates to systems and methods for implementing transactions involving copy-protected files.

### BACKGROUND

Known traditional systems of digital interactions, where the parties need to trust each other, heavily rely on real-time online validations. This results in delays and additional costs, making these interactions economically not viable. These transactions are always associated with risks and costs. The smaller the value within a transaction, the bigger the share of risks and costs associated with it. Given that transaction volumes grow over time, including microtransaction volumes, a number of technical challenges are presented.

These challenges include transaction security, ensuring that, for example, the same money cannot be spent twice. Traditional channels require Internet connection and adopt a wide range of security means to protect participants from fraud. Another challenge is transaction speed, which requires less expensive and instant transactions. Nowadays, instant transactions are considered a commodity. But there is no economically reasonable way to process microtransactions instantly and securely and profitably for those involved in the transaction. Traditional channels rely on expensive infrastructure that is associated with huge maintenance and scaling costs.

Therefore, there is a need for techniques for implementing low latency transactions while keeping security at a high level. Low cost transactions through more efficient offline channels are also desirable.

### SUMMARY

Systems and methods are disclosed for secure transaction and management of digital copy-protected files (DCFs). An issuer computing device comprises a processor and a nontransitory storage medium for storing instructions that, when executed by the processor, are configured to issue DCFs, perform transactions using the Protocol for Secure Transaction Records Management (Protocol STRM), and maintain a centralized transaction ledger, recording all DCF transactions. An issuer computing device generally refers to a device owned or controlled by an issuer of copy-protected files as well as devices owned or controlled by agents or licensees of the issuer, who may be acting on behalf of the issuer or licensed by the issuer. The files themselves and the ledger can be implemented as program code in a suitable programming language. Two or more user computing devices comprise an execution environment (EE) with Von Neumann architecture and an embedded secure element (SE) running an operating system (SE OS) with a separate execution environment (SE EE) based on the principles of Harvard architecture. The SE further comprises an isolated memory (SE IM) in communication with the SE processors and stores a Secured Digital Pocket (SDP) comprising a dedicated space in the isolated memory for storing DCFs. The SDP acts as a digital wallet. The SE also includes a File System for Secure Transactions (FSST) to store and manage DCFs within the SDP of the SDP CD. The SE further includes instructions that, when executed by the one or more processors, are configured to cause the system to maintain an embedded local ledger within the isolated memory of the computing device, configured for synchronizing with a DCF issuer's transaction ledger, establish a connection using Protocol STRM the DCF issuer computing device or external SDPs by a communication module, and receive, transfer, and validate DCFs.

In alternative embodiments, the EE is configured for communication with a processor and for storing instructions that, when executed by the one or more processors, are configured to cause the system to run an SDP application having access to the SDP and implement a graphical interface (GUI) of the SDP application. The isolated memory (SE IM) can be configured to securely store and manage DCFs, and the EE can comprise a memory configured to execute instructions related to the File System for Secure Transactions (FSST) and the Protocol for Secure Transaction Records Management (Protocol STRM).

In other embodiments, the issuer computing device validates DCFs as single objects in transactions between user computing devices. The issuer computing device can also issue DCFs and maintain a centralized transaction ledger to record all transactions involving the DCFs. The isolated memory can be configured to implement security measures on the stored DCFs within the SDP, including at least one of digital signatures, periodic validation, dedicated storage requirements, and mandatory Know Your Customer (KYC) or Know Your Business (KYB) procedures to unlock and use the SE.

Further alternatives include a Secured Digital Pocket (SDP) Application implementing Trusted Network Identification, scheduled synchronization, notifications, and a manual synchronization option. DCFs can be configured as Digital Copy-protected Files for Currencies (DCF-C) for use in financial transactions, including micro-transactions. The Digital Copy-protected Files for Currencies (DCF-C) can also feature a new file format with the extension .dcf, and the format includes Header, Cryptographic Section, Value Section, Local Transaction Ledger (Transaction Entries), Metadata. An FSST API can be implemented, related to DCF-C Operations and implementing synchronization, transaction operations, security and access Control, FSST management and utilities, extensions, and plugins. A Protocol Secure Transaction Records Management (STRM) can be implemented and configured for secure data exchange, error handling, rate limiting, fallback mechanisms, and a termination phase. In an embodiment, DCFs can also be transferred by establishing a communication link via the communication module using NFC or Bluetooth, or by other means of communication.

A method of exchanging digital copy-protected files (DCF) between a first Secure Digital Pocket (SDP) (acting as a type of digital wallet) with a first ledger and a second SDP with a second ledger is also disclosed. The method includes making a request, by the second SDP a certain amount of DCF from the first SDP, validating, by the first SDP, the request from the second SDP, signing and transferring DCF by the first SDP to the second SDP, validating, by the second SDP, the transferred DCF and updating the second local ledger. The method continues by sending, by the second SDP, a confirmation of transferred DCF to the first SDP and validating, by the first SDP, the confirmation and updating, by the first SDP, the first local ledger. Further operations include synchronizing, by the first SDP with the DCF issuer to offload the transaction history and validate the DCF and receiving, by the first SDP from the DCF issuer, instructions to update DCF and first local ledger. The method concludes by updating, by the first SDP, the DCF and first local ledger. The DCF and the local ledgers can keep less than the full transaction history, for example, by retaining only records between synchronizations with the issuer. This limitation of local transaction history can be used for privacy protection because otherwise each DCF user would have access to the other user's entire transaction history. Such metadata will be valuable to the issuer in most embodiments, but not to buyers and sellers in most exchange scenarios.

As with the exemplary system, the method can be implemented with DCF configured as Digital Copy-protected Files for Currencies (DCF-C) for use in financial transactions, including micro-transactions. The Digital Copy-protected Files for Currencies (DCF-C) can also feature a new file format with the extension .dcf, and the format includes Header, Cryptographic Section, Value Section, Local Transaction Ledger (Transaction Entries), Metadata. An isolated memory can also be used to implement security measures on stored DCFs within the SDP, including at least one of, digital signatures, periodic validation, dedicated storage requirements, and mandatory Know Your Customer (KYC) or Know Your Business (KYB) procedures to unlock and use the SE.

Another method of exchanging digital copy-protected files (DCF) involves a Secure Digital Pocket (SDP) with a first ledger and a DCF issuer with a second ledger. This method includes requesting, by the SDP, synchronization with the DCF issuer, receiving, by the SDP, an acceptance of the synchronization request from the DCF issuer, and sending, by the SDP, the last synchronization time and offloading transaction history to the DCF issuer. The method continues with receiving, by the SDP, confirmation from the DCF issuer of successful offload of the transaction history and receiving, by the SDP, instructions from the DCF issuer to update the first ledger. The method concludes with applying, by the SDP, the instructions received from the DCF issuer.

### BRIEF DESCRIPTION OF THE DRAWINGS

The following figures are included to illustrate exemplary embodiments.

FIG. 1 is a block diagram of an ecosystem for digital currency transactions, according to an embodiment.

FIG. 2 is a block diagram of a user device, according to an embodiment.

FIG. 3 is a block diagram showing interactions between ecosystem users, according to an embodiment.

FIG. 4 shows interactions between system users with a focus on transactions between a digital currency issuer and a user device, according to an embodiment.

FIG. 5 is a flow diagram of a transaction between system users, according to an embodiment.

FIG. 6 is an overview of the digital currency ecosystem implementing cryptographic features, according to an embodiment.

The embodiments described are exemplary ways to use the invention to solve technical problems in the field of the invention. The solutions and techniques disclosed may also be used to solve other problems in the field or to solve similar problems in other fields. Substitutions, modifications, and equivalents known to those of skill in the art may be used to implement these solutions and techniques, consistent with scope of the invention described in the claims.

### DETAILED DESCRIPTION

Systems and methods are disclosed for a digital ecosystem that manages secure transactions using copy-protected files. An exemplary system comprises an issuer, which refers to a trusted entity responsible for issuing copy-protected files. The issuer also controls and maintains a centralized transaction ledger. System users interact with the issuer by way of a secure digital space associated with user devices. The issuer is responsible for handling synchronization requests from system user devices.

Copy-protected files are distinguished by certain properties. Such files are copy-protected, which means that an attempt to create a digital duplicate of such a file results in creating a new object with another unique ID. Authenticity and integrity of this duplicate cannot be validated. Copy protected files also comprise security features. For example, such files are always signed by the issuer (central authority). Invalid issuer signatures are thus easily and quickly detected. A copy protected file periodically goes through mandatory validation by the issuer (the central authority), which allows for quick detection of duplicates. The file can be only stored within a dedicated area on the hardware, an area that uses a strictly tailored file system. A dedicated communication protocol is also used, which makes the file harder to forge. Wherever this file is stored, this dedicated area can only be unlocked and used by a user if they go through a mandatory KYC/KYB procedure with proper identification, such as a state-issued ID.

Another property of copy-protected files is uniqueness. For example, there is always a finite number of copy-protected files produced by the issuer and each copy-protected file is unique and can be identified. Each copy-protected file has a unique identifier, which is validated by the issuer. Invalid files, meaning those files with IDs not recognised by the issuer, will be easily and quickly detected. Copy-protected files may also be impartible, which means that they can only be transferred and validated as a single object. There is no way to split an impartible file into the parts and then “gather” the file from its parts.

Yet another property of copy-protected files is trackability. This means that every action performed with such a file is tracked, as well as every movement and location. The file issuer controls, and in a sense “owns” the files, the metadata, the central ledger and the file's full history. Such a file therefore contains its transaction history for the period of time in between mandatory or optional verifications by the issuer, creating no motivation for an attacker to forge the file. The general ledger on the issuer's side will detect when the duplication started and from where, clearly identifying the attacker and so that corrective action can be taken.

A copy-protected file is also transferable, meaning that the file can be transferred from the issuer to a dedicated secure space on a device belonging to a commercial organization, such as a bank or another business, or to a physical person. Thus the copy-protected file may be exchanged by participants of a typical transaction or microtransaction. In this context, A microtransaction is a small-scale monetary exchange that takes place within a digital environment, typically involving a minimal amount of money. These transactions are often carried out in online games, for example, where players can purchase virtual goods, services, or enhancements using real-world currency. Unlike traditional retail purchases, microtransactions involve tiny sums, making them suitable for items that have a low individual value.

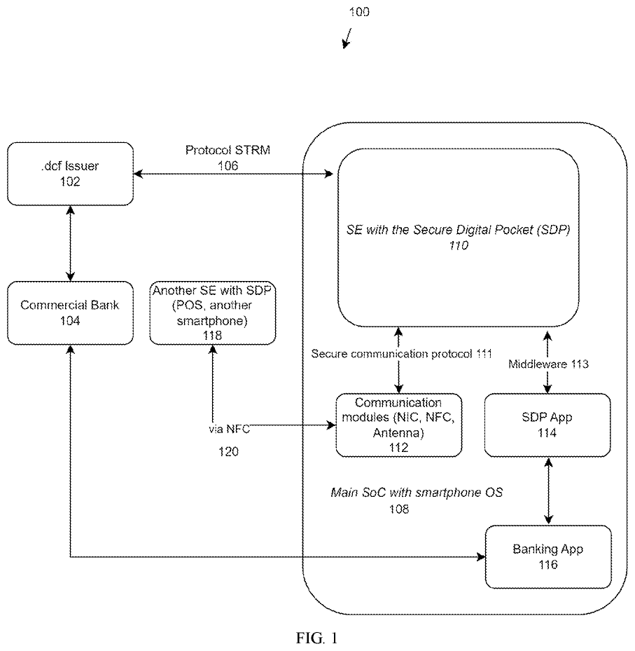

FIG. 1 shows an exemplary embodiment of an ecosystem 100 comprising an issuer of copy-protected (.dcf) files 102 and a commercial bank 104. The .dcf issuer uses Protocol STRM 106 as a communication link with specific components of Main SoC (system on a chip) with smartphone OS 108. In particular, the Protocol STRM 106 links .dcf issuer 102 with Secure Environment (SE) and its Secure Digital Pocket (SDP) 110. By way of middleware layer 113, an SDP Application 114 interacts with SE 110. Banking application 116 is also linked with SDP App 114 and communicates externally with the commercial bank 104. Also in communication with SE 110 by way of secure communication protocol 111 are one or more communication modules 112. These communication modules interact with another SE with an SDP 118 by way of NFC 120. The other SE will typically comprise a POS (point of sale) device or a mobile device, such as a smartphone. Instead of NFC 120, an internet connection or other wireless connection can be used. In embodiment, the entire transaction (or parts of it) can take place online by way of applications running on computing devices, including mobile devices, or by interacting with websites configured for buying, selling, or transferring .dcf files.

The system works with copy-protected digital files, also referred to as .dcf files. These files are maintained in a secure storage medium and have a unique file type designed to prevent tampering and unauthorized replication. Copy protection ensures that an attempt to create a digital duplicate of the file results in creating a new object with a different unique ID. Authenticity and integrity of this duplicate cannot be validated by the system and the duplicate will be unusable for exchange.

An SDP, such as SDP 110 in FIG. 1 can be used not only to store files and instructions, but also to control various aspects of a transaction. For example, an SDP can control the amount of money represented by DCFs in the storage at a given time. The SDP can also control the transaction process itself by preventing unauthorized access to DCFs and moving them to another storage without the owner (user) knowingly confirming the transaction. The SDP can further prevent duplicated or “lost” transactions by ensuring that certain DCFs are not written off more than once and that DCFs which are transferred are not removed without a confirmation that another SDP successfully accepted them.

Security measures implemented for the copy-protected file include signing by the issuer, which is typically a central authority, such as a private bank or public authority. An invalid issuer signature will be detected quickly, for example, by validating the signature with the central authority. The copy-protected file periodically goes through validation by the issuer that will identify and invalidate duplicate files. Validation can be scheduled for certain times or can take place randomly within certain parameters.

Further security is achieved by storing the file only within a dedicated area on the user's hardware device. For example, only a dedicated file system is used that is configured for use with the copy-protected file. A dedicated communication protocol is used, which makes it harder to forge because knowledge of the dedicated protocol is needed, in addition to knowledge of the dedicated file system. Also, wherever the copy-protected file is stored, the dedicated area will be secured. For example, the dedicated area can be unlocked only by users with predetermined credentials, such as users who have been prequalified based on Know Your Customer or Know Your Business (KYC/KYB) procedures and having a valid means of identification.

Each copy-protected file is unique, single, and trackable. A finite number of copy-protected files are produced by the issuer and each file can be uniquely identified. Invalid copy-protected files will not be acknowledged or validated by the issuer. Each copy-protected file is also transferred and validated as a single object. For example, the copy-protected file does not comprise a container or bundle of files such as a .zip file. The copy-protected file cannot be divided into parts or reconstructed from its parts and thus the entire file is needed to disclose its content. Actions performed with the copy-protected file, and the movement and location of the copy-protected file are tracked. The issuer maintains administrator rights over the copy-protected file, including file metadata, a central ledger, and full transaction history. The copy-protected file contains its transaction history for time periods between mandatory or optional or random verifications by the issuer. Thus, the general ledger on the issuer's side allows for detection of any duplication, including when, where, and how the duplication took place. This allows external attacks to be identified quickly and protective measures to be implemented.

Transfers of copy-protected files take place in several ways. One type of transfer originates with the issuer. The issuer transfers a copy-protected file to a dedicated secure space on a hardware device belonging to a commercial organization, such as a bank. The copy-protected file can also be transferred from the issuer to a non-banking entity or to a natural person.

Another type of transfer is between participants in a transaction. In this context, an exemplary device is used, the Secured Digital Pocket (SDP) and the copy-protected file will be referred to as a Digital Copy-protected File (DCF). The SDP acts as a digital wallet, a dedicated space for digital data on a user device, such as a mobile device such as a smartphone, where DCFs are stored. The SDP is configured to resist tampering and unauthorized access. The SDP is a storage system that relies on a modified Harvard architecture which isolates and secures the DCFs.

Harvard architecture generally refers to a computer architecture design where the storage and handling of data and instructions are physically separated. This means that the system has distinct memory blocks or buses for instructions (program code) and data, allowing for simultaneous access to both. This is unlike the Von Neumann architecture, where data and instructions share the same memory and pathways. In Harvard architecture, the CPU can read an instruction and perform a data memory access at the same time. This concurrency leads to increased performance, especially in systems where instruction fetch and data operations frequently overlap. One of the key features of Harvard architecture is that it allows for potentially different memory sizes and technologies for instructions and data. For example, instruction memory could be made faster and smaller, optimized for sequential access, as instructions are often fetched in a linear sequence. On the other hand, data memory might be larger and designed for random access. Harvard architecture also enhances security and reliability, as it prevents program memory from being overwritten by data processes, which can be a vulnerability in Von Neumann systems.

For the SDP and its stored DCFs, a modified Harvard architecture is used to handle traditional instruction and data memory separation. The SDP will therefore be configured so that specific memory areas dedicated to DCFs are both isolated and secured. A new file system, the File System for Secure Transactions (FSST), is used for storing and managing copy-protected files within the SDP. The FSST provides enhanced security, real-time synchronization capabilities, and optimized storage structures.

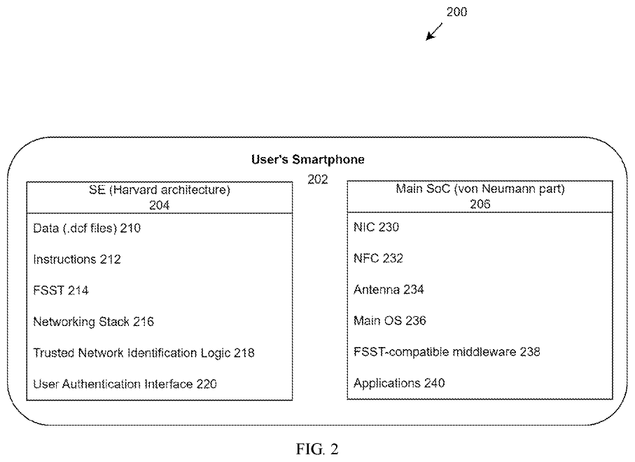

FIG. 2 shows a block diagram 200 of an exemplary user smartphone 202. As described above, an SE with Harvard architecture 204 is used to isolate key aspects of the digital pocket. For example, SE 204 comprises data (.dcf files) 210, instructions 212, FSST 214, networking stack 216, trusted identification logic 218, and user authentication interface 220. The main SoC 206, on the other hand, comprises NIC 230, NFC 232, antenna 234, Main OS 236, FSST-compatible middleware 238, and applications 240. These features will be explained in detail below.

Communications between the issuer and SDPs take place using a new, dedicated protocol, the Protocol for Secure Transaction Records Management (Protocol STRM). This protocol streamlines communication between the issuer and the SDP on a user's device. The Protocol STRM ensures a consistent, secure, and efficient system, optimizing both the synchronization process and the management of copy-protected files.

Offline operations are implemented through an embedded local ledger on the users' side. The local ledger synchronizes with the general ledger and offloads transactions to the general ledger maintained by the issuer.

Security features are achieved through the copy-protected file's dedicated file structure (.dcf), a dedicated communication protocol with the issuer (Protocol STRM), and a dedicated file system (FSST) configured on hardware with modified Harvard architecture. Other security features are achieved with embedded transaction limits and verification capabilities, as well as mandatory periodic verification checks. Consistency is maintained through a regularly updated local transaction ledger that offloads transactions to the general ledger maintained by the issuer.

Low-cost transactions can be made efficiently because the system's dedicated components are configured specifically for secure digital transactions. Offline transaction capabilities also ensure fast peer-to-peer exchanges without waiting for online verification. Security features are implemented by the copy-protected file's structure, the FSST design, the Protocol STRM, and hardware modifications for the SDP. The system has complete transparency because the issuer maintains a complete record of all transactions.

A Digital Copy-protected File (DCF) is used for financial transactions and especially suitable for transactions. In an embodiment, Digital Copy-protected Files for Currencies (DCF-C) are implemented as a digital representation of a currency, such as banknote or coin issued by a public authority. The DCF-C comprises a file type with .dcf extension and is protected such that it cannot be copied or spoofed in an economically reasonable time. The .dcf file format ensures that every DCF-C conforms to a specific structure. The dedicated file format allows the DCF-C to be used efficiently in different commercial settings, including internationally. The dedicated file format incorporates security features specific to the use of DCF-C in commercial transactions. For example, a .dcf file must be encrypted so that only authorized systems and users can decrypt the file and access its details. The unique .dcf extension allows devices, applications, and systems to identify and process the file and handle it according to predefined protocols. These protocols include, for example, validating the file, checking its value, transferring it to another user, and so on.

A Digital Copy-protected File for Currencies format (.dcf) comprises dedicated sections. The include a header section that identifies information such as the .dcf file format version, issuer details, and a unique identifier (UID) for each DCF-C. A cryptographic section includes a digital signature to authenticate the issuer and verify the integrity of the file. In an embodiment, the digital signature requires a periodic sync with the issuer to ensure the signature's validity. The cryptographic section can also include information about the encryption used to secure the file. A value section stores the monetary value of the file, such as $1, $5, or $10. The values section also stores a verification date. This verification date refers to the mandatory date after which the DCF-C must be synced with the issuer before being used in further transactions. This verification ensures that the file hasn't been tampered with or misused while offline.

The value section can optionally include a replacement date, which is the date after which the DCF-C can no longer be used. This replacement date can be deactivated by setting it to null or made mandatory to recognize and apply by setting it to a non-null value. The value section in the .dcf file can be used to accommodate currency replacement in a country. For example, a switch from a local, national currency to a common currency such as a euro. Currency denomination can also be adjusted, for example, by setting the original value of “1000” equal to a new value of “1”. Certain nominal deprecation can also be implemented, for example, by specifying that digital currency of value equal to “500” can no longer be used after a specific date.

A local transaction ledger is used to track transactions involving the .dcf file. The ledger comprises entries including timestamps of transactions (date and time), the sender's SDP ID (a unique identifier for the sending SDP). The SDP ID can optionally be encrypted for enhanced security. The ledger also includes the recipient's SDP ID, which is also a unique identifier but for the receiving SDP. Encryption can optionally be used for the receiving SDP ID. Other ledger entries include a transaction ID. The transaction ID is a unique identifier for each transaction, and can be implemented as a cryptographic hash of transaction details. Examples of cryptographic hash algorithms that can be used include SHA-256 (Secure Hash Algorithm 256-bit), which is part of the SHA-2 family and produces a 256-bit hash value. Alternatively, SHA-3 can be used. SHA-3 is a subset of the cryptographic primitive family KECCAK. It offers various hash lengths like SHA-3/256, SHA-3/384, and SHA-3/512.

The ledger also comprises an entry for the number of offline transactions allowed. This field indicates how many offline transactions are allowed before a central validation is required. The entry for the number of offline transactions allowed can be configured to have a default value set by the issuer, which decreases with each offline transaction. When the value reaches zero, the DCF-C must be validated online before further use. A date can be added so that further DCF-C usage is blocked until an online check is performed when either the date is reached or the maximum number of allowed transactions is reached.

The ledger further comprises an entry for additional metadata such the Issue Date, which is the date the DCF-C was created. The ledger also includes an entry for the Last Sync Date. This date refers to the last date the DCF-C was validated or synced with the issuer's ledger. The ledger can include other information relevant tracking and auditing transactions made with the .dcf file.

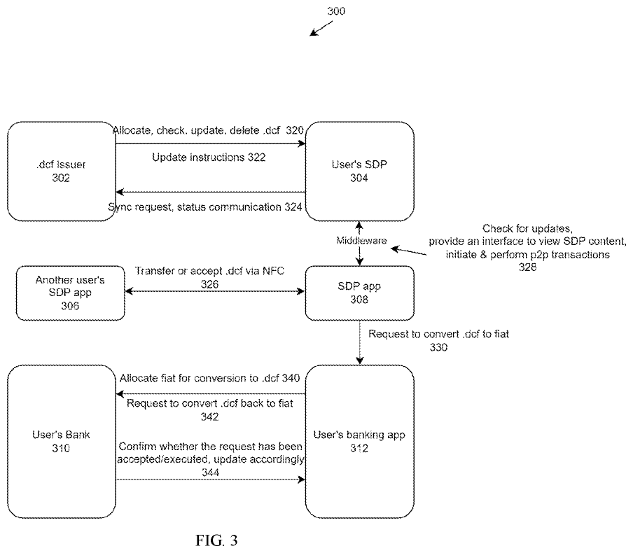

FIG. 3 shows an exemplary series of transactions 300 between ecosystem members. The ecosystem comprises .dcf issuer 302 sending some money value to a user's SDP 304 using .dcf files. The user's SDP 304 communicates with SDP Application 308 on the user's mobile device and the SDP application in turn communicates with another user's SDP application 306, as well as with banking application 312. Banking application 312 communicates with the user's bank 310.

At operation 320, .dcf issuer 302 allocates, checks, updates, and deletes .dcf files on user's SDP 304. At operation 322, .dcf issuer 302 can also update instructions that pertain to the .dcf files. In response, the user's SDP 304 sends sync request and status communications to the .dcf issuer at operation 324.

When making a transaction using .dcf “coins,” at operation 326 the SDP application 308 on the user's mobile device communicates with another user's SDP application 306 to accept or transfer .dcf using NFC. In use, SDP application 308 will periodically check for updates and provide an interface for the user to interact with SDP 304 by way of middleware layer 328.

When .dcf currency has been exchanged, SDP application 308 requests form the user's banking application 312 the conversion of .dcf to fiat currency, such as a government-issued note. Banking application 312 allocates fiat currency for conversion to .dcf at operation 340 and can also request conversion of dcf back to fiat currency at operation 342. At operation 344, the user's bank 310 confirms where the request has been accepted and the user's account is updated accordingly.

A File System for Secure Transactions (FSST) is used consistent with the security requirements and the specific nature of the *.dcf files. This file system resides within the data section of a modified Harvard architecture and is designed specifically for handling *.dcf files, ensuring optimal speed, reliability, and atomicity of transactions. Security features comprise inherent encryption, integrity checks, and anti-tamper mechanisms. The FSST is also configured for atomic transactions. This ensures that operations, such as transferring a *.dcf file from one user to another are atomic in nature. In this context, atomic means that the transaction is either fully complete or doesn't happen at all. The FSST is configured specifically for the nature of the data stored within it. For example, file systems such as NTFS and ext4 are general-purpose filesystems with a wide range of features while FSST is specialized for a specific type of transactional data involving .dcf files and offers features tailored to .dcf transactions.

An exemplary transaction using the DCF-C ecosystem comprises a buyer and seller in a low-value transaction. For example, the buyer is a person who wants to buy a cup of coffee for 1$ in a cafe. The buyer chooses to pay with copy-protected digital currency (or “coins”) in the digital pocket on the buyer's mobile device. The buyer's mobile device interacts with the merchant's terminal (by tapping, keying, etc.) and authorizes the purchase. The merchant instantly gets a signed bill from the buyer. The transaction is confirmed and completed successfully if the buyer has enough coins to spend and the bill is successfully created and signed. The merchant claims the money received from the buyer by using an Internet connection. The buyer's coins (the copy-protected files) used for this purchase are “flagged” with a transaction ID and timestamp. The value of these coins is no longer available. Once the transaction history is generated and saved, for example, in the issuer's ledger, the record of these coins in the buyer's ledger is automatically destroyed.

An alternative exemplary transaction begins when the user unlocks their mobile device, authorizes the wallet application installed on the mobile device, and brings the mobile device close to a point of sale (POS) device. The POS device requests a specific amount for the transaction. Client-based validation is then performed to confirm that the wallet has enough “coins.” The wallet application then provides a yes or no answer. If the answer is no, the transaction is terminated and the user is notified about an error. If the answer is yes, the user is asked to sign the transaction (with PIN, biometrics, etc.) and the POS device accepts. The POS device communicates back that the transaction is accepted and completed. In an embodiment, this is accomplished by a signed message with the signature of the merchant's wallet. The message is validated and accepted by the buyer's wallet. A transaction processor adds a transaction ID and timestamp to the coins “spent” in the transaction. These coins are no longer available in the wallet to spend. The remaining coins are grouped and a transaction history is generated and saved in the local ledger. The transaction processor activates a coin destruction mechanism. After the next sync with the issuer's ledger, the locally stored transaction history will have been offloaded to the issuer. The local history can then be deleted.

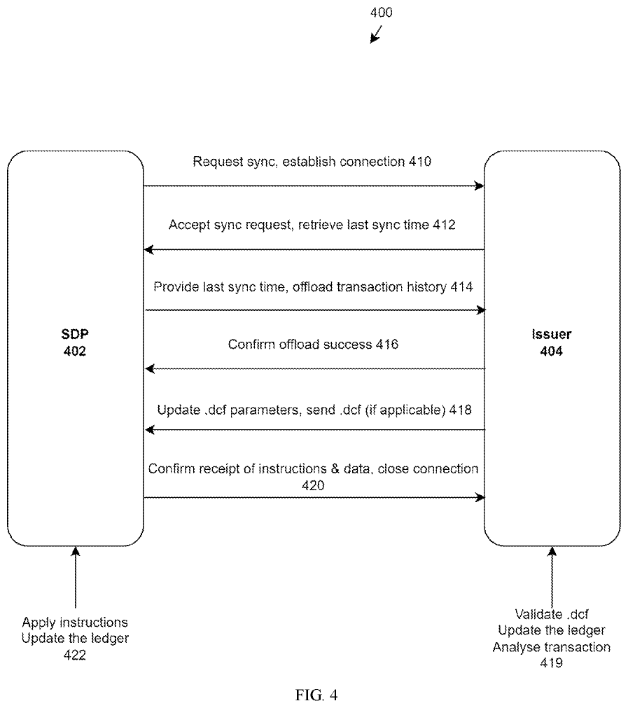

FIG. 4 shows an exemplary series of operations 400 whereby SDP 402 and issuer 404 sync their respective ledgers. At operation 410, SDP 402 requests synchronization and establishes a connection with issuer 404. Then at operation 412, issuer 404 accepts the synchronization request and retrieves the last synchronization time. SDP 402 provides the last synchronization time and offloads its transaction history at operation 414. Successful offload on the issuer's side 404 is then confirmed at operation 416. Issuer 404 further updates .dcf parameters and sendings .dcf (if applicable) at operation 418. SDP 402 confirms receipt at operation 420 and closes the connection.

After synchronization, SDP 402 applies any instructions from issuer 404 and updates its local ledger at operation 422. Issuer 404 validates .dcf and updates its ledger at operation 419. Issuer 404 can also analyze the transaction with SDP 402, including transaction history involving SDP 402 or the .dcf at issue in the transaction.

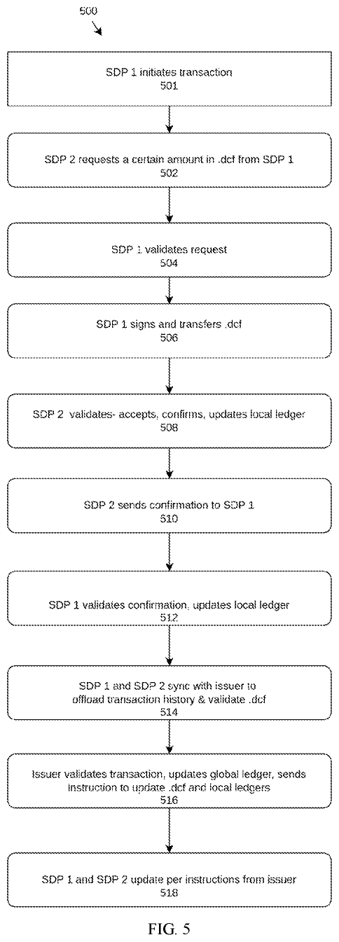

FIG. 5 shows an exemplary transaction 500 where a transfer, such as a payment, is made between two ecosystem users by way of SDPs. The parties to the transaction will be referred to by way of their SDPs, with SDP 1 representing the buyer and SDP 2 representing the seller. The transaction begins at operation 501, when the buyer (SDP 1) expresses an intent to transfer .dcf to SDP 2. The exchange can be in connection with a commercial transaction where SDP 1 receives an object, service, or property right in exchange for .dcf. Alternatively, the transfer can be a gift or other non-commercial transaction. In some embodiments, operation 401 is optional, for example, when the transaction is initiated by the seller's request for payment at operation 502. At operation 502, SDP 2 requests an amount of money in .dcf from SDP 1. SDP 1 then validates the request at operation 504 and signs and transfers .dcf at operation 506. At operation 508, SDP 2 validates the transfer and confirms and accepts it, updating SDP 2's local ledger. SDP 2 then sends the confirmation to SDP 1 so that SDP 1 can validate the confirmation and update its local ledger at operation 512.

The previously-described operations 501-512 may have taken place offline. Operation 514 takes place when SDP 1 is back online and synchronization with the .dcf issuer is possible. Synchronization with the .dcf issuer offloads the transaction history and validates .dcf in the SDP. At operation 516, the .dcf issuer validates the transaction, updates its global ledger, and sends instructions to SDP 1 to update its .dcf and local ledger entries. The cycle completes when SDP 1 updates its .dcf and ledger in accordance with the .dcf issuer's instructions. Operation 516 can be performed asynchronously, not at the time of the transaction itself. Operation 516 can be performed offline and can optionally include a group of transactions, which are validated as part of a batch. For example, validation can comprise all transactions within a 24-hour period.

In an embodiment, operation 506 always requires authorization. Typically, the user who will be sending DCFs will be required to authorize the transfer. For example, when making a transaction the sender's interaction is needed to verify that the sender consents to the transaction. In this embodiment, DCFs cannot be transferred without the user's knowledge. In the embodiment shown in FIG. 5, SDP2 is typically a seller and SDP1 is a customer who pays with DCF. 4.

Operation 514 typically involves both SDP1 and SDP2 because both will off-load transaction histories to the central ledger. This can happen at different times, however, and generally takes place after the transaction is completed. Operation 518 also typically applies to both SDP1 and SDP2.

In a further aspect, the coins are “named.” In an embodiment, the coins are named by a bank for exactly one specific digital wallet, which is transferred to a user. This naming acts as a transfer of ownership. Usually the bank has control of the money and users control their bank account and can access the money allocated to that bank account. In this embodiment, however, ownership is transferred to a specific user. Users can initiate the process through their banking applications. Coins can be transferred to the same wallet from different banks if, for example, the user has multiple banking applications. But a user can have one personal wallet, and this wallet must be registered with the user's unique identification information, such as tax ID, ID issued by a public authority, and a user-specific alphanumeric code.

Coin generation proceeds from a signature by a bank to ensure authenticity and confirm the legitimacy of the issuer of a particular coin. A signature by the wallet to which the coin is issued is also needed. Thus, only a specific wallet can accept the coin. A signed confirmation verifies the number of coins that will appear in the user's wallet. The coins, once generated in the wallet, never leave the wallet, which is located in the secure enclave. Once spent and marked with transaction ID and timestamp, the coins are automatically destroyed within a specified time.

Alternatively, a tracking mechanism is used that allows for tracking of any fraud involving the wallet. In this case, a would-be attacker is not motivated to copy the coins because the transaction history will identify the attacker's wallet. Fraud can also be deterred by configuring the system for tracking the reputation of each wallet, each wallet holder's reputation, or the reputation of particular digital coins. These values can be used in a recommendation engine that can be used to decide whether it is safe to enter transactions with a given wallet, user, or combination of coins.

In an embodiment, a natural person (individual) or a legal entity registers an electronic wallet with their unique user identification number such as a government-issued ID. Digital coins can be added to the electronic wallet through the user's bank. One minimum denomination of coins is used and further transactions can be made with these coins. When making a transaction, the receiving party assumes the risk, accepts the coins, and transfers them further along the transaction chain. Alternatively, the receiving party does not take on the risk. A request is sent to the issuer bank by the seller, and the issuer bank verifies the transaction history for each coin. The issuer bank then confirms that the coins are authentic. If the coins are not authentic or have previously been canceled in whole or in part, the issuer bank informs the seller. The issuer bank will see from the transaction history, starting from the wallet in which the coin originally appeared. This history will reveal the nature of divergence between the local ledger and issuer ledger and the specific reason why spent coins were not destroyed. The issuer bank can then notify relevant government agencies in case of fraud and use the transaction history as the basis for further investigation.

In an embodiment, DCF-C operations comprise a series of distinct operations. First, a new DCF-C is generated with specified parameters, including value, verification date, and a maximum number of offline transactions. Details of a specific DCF-C can be read from its .dcf file. File attributes can also be updated, such as marking the coin expired or updating the offline transaction count. A DCF-C can also be removed from the system.

A synchronization operation is used to update transaction history. Synchronization includes syncing with the issuer to offload the local transaction history and updating details of the DCF-C. The current synchronization status can be checked by an operation such as Retrieve Sync Status, which checks the current synchronization status and gets details of any recent sync operations.

Transaction operations include operations such as initiating an offline transaction. This starts the process for an offline transaction between two devices. Another transaction operation is used to validate a DCF-C for use in transactions. This check determines whether a DCF-C is valid and available for a transaction. For example, this check queries the number of remaining offline transactions to determine whether further offline transactions are available.

Security and access control operations include authentication by verifying the identity of a user or the credentials of a system trying to access the FSST. Another operation comprises checking for permissions of the requesting user or requesting the system for a specific operation. Further operations include retrieving a log of all operations performed via an API for tracking and monitoring. This API will be described in more detail below.

Operations also include those for FSST management and utilities. Exemplary operations comprise checking FSST health, whereby the FSST is verified as functioning correctly and checked for any potential issues. Another operation comprises backup and restore operations, which includes tools for creating backups of the FSST and restoring the FSST from a backup. The FSST can also be modified by an operation that adjusts the FSST's settings and configurations. The FSST can optionally be configured to allow for extensions and plugins to extend its capabilities.

The ecosystem can optionally include features to improve usability, user experience, and reliability of the system as a whole. These features include version control, where different versions of DCF-C files or the FSST itself are tracked. Migration tools can also be provided to assist in migrating data between different versions. Performance monitoring can be achieved by collecting data related to the performance of the FSST, such as read/write speeds, average response times, and so on. Performance optimization features or tools can also be added to help in fine-tuning the FSST for optimal performance. For disaster recovery, the system provides for periodic snapshots of the FSST for quick rollbacks. A recovery mode can also be provided that allows for recovery of FSST data after catastrophic system failures. Data integrity and redundancy can be implemented with checks to verify the integrity of the .dcf files and other FSST data structures. Redundant data can be used to prevent data loss, by for example, implementing Redundant Array of Independent Disks (RAID). Localized language support can be implemented so that when the FSST gets exposed to end-users, system messages are offered in local languages. Localization can also be implemented through currency and regional settings to ensure compatibility with regional monetary formats. Notifications and alerts can be provided for specific events. For example, notifications can be provided that allow systems or system users to subscribe to specific FSST events, such as when a particular .dcf file is about to expire. The mechanism for these notifications include push notifications, email messages, in-app pop-up notifications, and so on.

The ecosystem is extensible and provides for developer support and documentation to assist third-party development. This includes API documentation comprising comprehensive guides and references for developers interacting with the FSST. Other developer support tools include software development kits (SDKs) or libraries to facilitate the integration process for third-party developers. Further customization for third-party integrations includes providing for a plugin system for developers. Custom modules can also be provided to enhance or modify the FSST's default functionalities.

An FSST API is provided as a mechanism for integrated synchronization. FSST's API has a built-in real-time sync capability to maintain data consistency between local and central storages. The FSST API includes advanced authentication, authorization, audit capabilities, and potential integration with hardware-level security mechanisms. Offline transactions are managed and validated through the FSST API. The FSST API can help devices determine the validity of a .dcf file for offline transactions and keep track of offline transaction counts. The FSST API is configured for deep data integrity verifications, ensuring that stored .dcf files and their associated transaction histories remain uncorrupted. Another feature of the FSST API is real-time disaster recovery and redundancy. The FSST API is further configured to trigger and manage disaster recovery processes (like snapshots and recoveries). Notifications can be customized so that event subscription and notification mechanisms allow for personalized user experience. Stakeholders can thereby be alerted about specific events, such as impending .dcf verifications. FSST-specific extensions and plugins can be enabled using the FSST API to support ongoing development of additional FSST features.

The Protocol for Synchronisation and Transaction Records Management (Protocol STRM) comprises a series of operations. A handshake and authentication operation takes place before data exchange to establish a secure connection. This involves mutual authentication to confirm the legitimacy of the SDP on a local device and the issuer. Exemplary methods include certificate-based authentication, tokens, or other security means.

A query and response operation comprises the SDP sending a query to check whether any of its *.dcf files need synchronization. This prevents unnecessary system load, for example, by not synchronizing if a synchronization already took place within a specific time range. The time range selected for a particular system can be a certain number of hours depending on system load, such as 12 hours, 18 hours, or 24 hours.

A data exchange operation comprises transaction offloading whereby a local device dispatches batches of transaction records to the issuer. Once successfully logged by the issuer, the local device is permitted and, in some embodiments, required to clear the transaction records. The issuer can also choose to update *.dcf files from time to time. For example, the central authority might send revised *.dcf files back to the SDP. The file update can reconcile inconsistencies, refresh verification dates, or apply other file updates.

A verification and acknowledgment operation comprises an exchange of acknowledgment messages by the issuer and the local device. For example, after recording the transaction history, the issuer dispatches a confirmation to the local device, which can then erase its local transaction records. When the local device forwards transaction history to the issuer and after verification of successful recording of that transaction history by the issuer, the local transaction history can be cleared to maintain storage efficiency, security, and performance.

A closure operation comprises securely terminating the connection after all necessary data exchanges and confirmations are concluded. Both the local device and the issuer log the synchronization process, forming an audit trail that includes transaction details and related metadata.

Other protocol operations comprise error handling by way of built-in mechanisms to identify and respond to errors. When discrepancies or synchronization failures are identified, defined corrective measures can then be initiated. Synchronization rates can be limited or throttled by the protocol to avoid system overwhelm, for example, during high traffic periods. When the primary synchronization method is unavailable, such as a Wi-Fi internet connection, the protocol switches to alternative mechanisms, such as mobile data. Synchronization preferences can be set based on user preferences and potential cost implications.

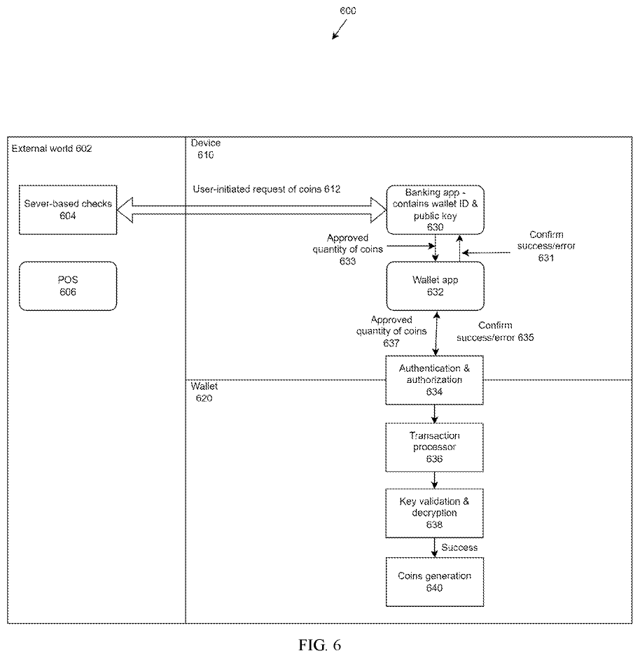

FIG. 6 shows a block diagram of an exemplary system 600 that implements delivery of digital coins to a user wallet (SDP) using cryptographic security features. On one side, the ecosystem is divided into an external world 602 comprising a server-based checking device 604 and a POS device 606. On the other side, the ecosystem comprises a user device 610. These boundaries are crossed by user initiated requests for digital coins by way of communication channel 612.

User device 610 comprises an isolated wallet 620. User device 610 is typically a mobile device, such as a smartphone. A banking application 630 stores the user's wallet ID and public key. The banking application 630 communicates with wallet application 632 to deliver an approved quantity of coins (633) and to receive confirmation (631) of success or errors from wallet application 632. At the interface of wallet 620 and device 610, an authentication and authorization module 634 approves the quantity of coins received (634) and also confirms success or errors (635). The coins received are then passed to transaction processor module 636. Key validation and decryption takes place by way of module 638 and, if successful, coins are generated in secure area 640 of wallet 620.

The SDP application comprises a number of features that integrate the SDP with the ecosystem as a whole. The use of verification dates and a maximum number of offline transactions allowed between online checks is one such feature. This means that DCF-Cs can be mixed in users' SDPs and DCF-Cs have different verification dates and a number of offline transactions. The limit on offline transactions prevents such transactions from accumulating and reduces the chance or error or abuse based on the time gap between online checks. The SDP application acts as an interface between the user and the actual, hardware-based SDP to make ecosystem interactions seamless from the user's perspective. The SDP application identifies and remembers trusted networks, such as a home Wi-Fi connection. The SDP application can also allow users to either set a specific time for the sync (like every day at 2 AM) or allow the SDP app to pick optimal times based on user behavior, such as when the host mobile device is charging. In most cases, a sync will be silent, but a notification can be given for a successful sync and any updates or changes made to their DCF-Cs. Other notifications can be used for users who might not regularly connect to trusted networks. This mechanism ensures these users are reminded to manually initiate DCF-Cs validation after a certain time has passed or after a certain number of transactions. When users are about to make a large or important purchase, a manual sync can be implemented that ensures all DCF-Cs are up-to-date. The cost of this check should not be allocated to transaction costs because it happens outside the transaction, is not necessary, only takes place because of a user's particular situation and preferences.

The silent background sync ensures that users won't be frequently interrupted by validation demands, leading to a smoother user experience. Having updates during times when the user is less likely to be actively using the host mobile device (e.g., period of sleep), the SDP application is less likely to interfere with other tasks or be perceived as slowing down the host mobile device. When the sync happens primarily over Wi-Fi, particularly home networks, mobile data use is avoided. Performing syncs over trusted networks also reduces the risk of man-in-the-middle attacks or other vulnerabilities associated with public networks. If implemented properly, this approach ensures that the majority of DCF-Cs in circulation are regularly validated and updated, making the overall system more secure and at the same time reducing transaction costs.

The real-time sync with an issuer takes place when the FSST establishes a connection with an issuer by way of a central server to validate transactions and perform other tasks or updates. The issuer can back up the *.dcf files or restore them in the event of data loss or when the SDP is transferred to a new device. Any unusual patterns or suspicious transactions can also be flagged during sync for further investigation.

Real-time transaction between devices refers to immediate and fast exchange of *.dcf files between two devices, for example by direct peer-to-peer transfer. Such transfers are typically performed using technology such as NFC or Bluetooth, but other means of communications can also be used.

The bridge between the SDP SE (Secure Element) and the SDP application comprises a middleware layer, in this context an FSST-compatible layer, that acts as an intermediary between the high-level SDP application running on the main host device OS (e.g. Android, IOS, etc.) and the low-level secure file system (FSST) and SDP operations within the Secure Element (SE). This layer can be described as a software bridge that allows for secure and controlled interactions between the user-facing SDP application and the secure hardware of the SDP SE. Physically, the middleware can be implemented as a service or a set of services running in the main host device OS environment. Logically, the middleware can be implemented as a layer or a stack of components, each responsible for different aspects of the interaction between the wallet application and the FSST. The middleware includes security features that ensure that all communications are securely transmitted, preserving the integrity and confidentiality of system data. The middleware also translates high-level API calls from the SDP application into low-level commands that the FSST understands, and vice versa. The middleware also provides access control by enforcing access policies and ensuring that only authorized applications and users can interact with the secure wallet functions. The middleware further acts as an abstraction layer. For example, the middleware abstracts the complexities of the FSST and SE, presenting a simple interface to the SDP application.

The middleware layer comprises a number of components. These include an API Interface, which includes a set of APIs that the SDP application can use to perform operations like checking balances, initiating transactions. In an alternative embodiment, the operations also include syncing with the issuer. A command processor interprets API calls and converts them to FSST commands. A cryptographic service provides cryptographic functions such as encryption, decryption, and digital signatures to the SDP application. A session manager manages sessions between the SDP application and the FSST and optionally uses tokens or session keys to maintain a secure connection. An error handling feature captures and manages errors, ensuring that the SDP application is aware of issues that occur during FSST interactions.

In an embodiment, the SDP application comprises a graphical user interface (GUI). This type of user interface allows users to interact with electronic devices through graphical icons and visual indicators. Unlike text-based interfaces that rely on typed commands, GUIs present information using visual elements. These components include icons, menus, buttons, windows, and other widgets. Users can directly manipulate these graphical elements to perform actions.

Security features of the middleware layer comprise on-access monitoring. When active, the monitoring runs real-time checks for detecting and responding to security threats or anomalies in transaction patterns. The monitor can optionally adjust its security measures based on the current threat level, enforcing stronger security during high-risk operations. An update management feature can also be deployed that manages updates to the FSST or SE firmware, ensuring that the SDP is always running the latest, most secure version. Data synchronization can also be a feature of the middleware layer, providing a synchronization logic for determining the optimal times to sync with the issuer and managing data transfer efficiently.

Because the system is designed to facilitate offline interactions between buyers and sellers, as well as periodic online validations, the use of network and NFC communication modules by the SE is provided for. A Network Interface Controller (NIC) is provided for establishing network connections for syncing with the issuer. An antenna can also be configured to connect to wireless networks and to enable NFC communication. An NFC module can be deployed for close-range (near-field) transactions using NFC. Network protocols, such as TCP/IP for internet communications, and possibly HTTPS for web-based interactions. Trusted network identification logic is used to ensure the mobile host device only communicates over user-confirmed trusted networks. Secure communication protocols such as TLS/SSL can optionally be used to secure data in transit. A user authentication interface can be provided for the user to grant the SE permission to access network resources, if these resources are not embedded into the SE.

In an alternative embodiment, the SE includes integrated communication control. This is accomplished on the SE side by way of a lightweight networking stack that handles network protocols like TCP/IP. This allows the SE to process network requests and prepare data packets for transmission. The SE can also comprise trusted network identification logic to recognize and connect only to networks that have been pre-approved as trusted by the user, enhancing security for data transmission. A user authentication interface within the SE can be deployed to manage user authentication, allowing the SE to confirm user permissions for accessing network resources.

On the main SoC side, an antenna is used for wireless communication capabilities, including Wi-Fi, cellular data (such as LTE, 5G), and NFC (for near-field communication tasks). An NFC module initiates contactless transactions and facilitates communication with other NFC-enabled devices, such as point-of-sale (POS) terminals or other mobile devices, such as smartphones. A Network Interface Controller (NIC) manages access to the network, handling the physical and data link layers of network communication.

In an embodiment, communication between SE and SoC works by way of a number of exemplary operations. First, when a network task is initiated, the SE prepares the necessary data using its integrated networking stack and signals the main SoC to handle the physical transmission.

The main SoC receives these instructions and uses the NIC to manage the connection to the wireless network using the antenna. For NFC transactions, the SE prepares the transaction data and uses the NFC module in the main SoC to transmit the data to the NFC reader or another NFC-enabled device. The user authentication interface in the SE ensures that network access and NFC transactions are only performed after proper user authorization, adding an extra layer of security. By distributing the tasks this way, the SE with integrated communication control leverages the full capabilities of the mobile host device's hardware for networking and communication while maintaining a high level of security for sensitive operations. The SE's direct control over network-related software logic ensures a secure environment for processing and preparing data for transmission, while the SoC's hardware handles the actual communication with external networks and devices.

1. A system for secure transaction and management of digital copy-protected files (DCFs), comprising:
an issuer computing device comprising a processor and a nontransitory storage medium for storing instructions that, when executed by the processor, are configured to:
issue DCFs, perform transactions using the Protocol STRM, and maintain a centralized transaction ledger, recording all DCF transactions;
two or more user computing devices, each comprising an execution environment (EE) with a shared nontransitory storage medium and an embedded secure element (SE) running an operating system (SE OS) with a separate execution environment (SE EE);
wherein the SE further comprises an isolated storage memory (SE IM) in communication with the SE processors and stores:
a Secured Digital Pocket (SDP) comprising a dedicated space in the isolated storage memory for storing DCFs;
a File System for Secure Transactions (FSST) to store and manage DCFs within the SDP of the SDP CD;
instructions that, when executed by the one or more processors, are configured to cause the system to:
maintain an embedded local ledger within the isolated storage memory of the computing device, configured for synchronizing with a DCF issuer's transaction ledger;
establish a connection using a Protocol for Secure Transaction Records Management (Protocol STRM) the DCF issuer computing or external SDPs by a communication module; and
receive, transfer, and validate DCFs;
wherein the EE is configured for communication with a processor and for storing instructions that, when executed by the one or more processors, are configured to cause the system to:
run an SDP application having access to the SDP; and
implement a graphical interface (GUI) of the SDP application.

2. The system of claim 1, wherein the isolated storage memory (SE IM) is configured to securely store and manage DCFs, and the EE comprises a memory configured to execute instructions related to the File System for Secure Transactions (FSST) and the Protocol for Secure Transaction Records Management (Protocol STRM).

3. The system of claim 1, wherein the issuer computing device validates DCFs as single objects in transactions between user computing devices.

4. The system of claim 1, wherein the issuer computing device issues DCFs and maintains a centralized transaction ledger to record all transactions involving the DCFs.

5. The system of claim 1, wherein the isolated storage memory is further configured to implement security measures on the stored DCFs within the SDP, including at least one of:
digital signatures;
periodic validation;
dedicated storage requirements; and
mandatory Know Your Customer (KYC) or Know Your Business (KYB) procedures to unlock and use the SE.

6. The system of claim 1, further comprising a Secured Digital Pocket (SDP) Application in communication with at least one of the user devices, the SDP implementing:
Trusted Network Identification;
scheduled synchronization;
notifications; and
a manual synchronization option.

7. The system of claim 1, wherein the DCFs are configured as Digital Copy-protected Files for Currencies (DCF-C) for use in financial transactions comprising micro-transactions.

8. The system of claim 7, wherein the Digital Copy-protected Files for Currencies (DCF-C) include a file format with the extension .dcf, and the format includes Header, Cryptographic Section, Value Section, Local Transaction Ledger (Transaction Entries), and Metadata.

9. The system of claim 7, further comprising an FSST API related to DCF-C Operations implementing synchronization, transaction operations, security and access Control, FSST management and utilities, extensions, and plugins.

10. The system of claim 1, wherein the Protocol STRM is configured for:
secure data exchange,
error handling,
rate limiting,
fallback mechanisms, and
a termination phase.

11. The system of claim 1, wherein one of the two user devices is configured to receive and transfer DCFs by establishing a communication link via the communication module using NFC or Bluetooth.

12. A method of exchanging of digital copy-protected files (DCF) between a first Secure Digital Pocket (SDP) with a first local ledger and a second SDP with a second local ledger, the method comprising:
making a request, by the second SDP a certain amount of DCF from the first SDP;
validating, by the first SDP, the request from the second SDP;
signing and transferring the DCF by the first SDP to the second SDP;
validating, by the second SDP, the transferred DCF and updating the second local ledger;
sending, by the second SDP, a confirmation of the transferred DCF to the first SDP;
validating, by the first SDP, the confirmation and updating, by the first SDP, the first local ledger;
synchronizing, by the first SDP with the DCF issuer to offload the transaction history and validate the DCF;
receiving, by the first SDP from the DCF issuer, instructions to update the DCF and the first local ledger; and
updating, by the first SDP, the DCF and first local ledger.

13. The method of claim 12, wherein the DCF are configured as Digital Copy-protected Files for Currencies (DCF-C) for use in financial transactions comprising micro-transactions.

14. The method of claim 13, wherein the Digital Copy-protected Files for Currencies (DCF-C) include a file format with the extension .dcf, and the format includes Header, Cryptographic Section, Value Section, Local Transaction Ledger (Transaction Entries), and Metadata.

15. The method of claim 12, wherein an isolated storage memory is configured to implement security measures on stored DCFs within the SDP, including at least one of:
digital signatures;
periodic validation;
dedicated storage requirements; and
mandatory Know Your Customer (KYC) or Know Your Business (KYB) procedures to unlock and use the SE.

16. The method of claim 12, wherein the SDP is accessed on a user device by way of a Secured Digital Pocket (SDP) Application implementing:
Trusted Network Identification;
scheduled synchronization;
notifications; and
a manual synchronization option.

17. A method of exchanging of digital copy-protected files (DCF) between a Secure Digital Pocket (SDP) with a first ledger and a DCF issuer with a second ledger, the method comprising requesting, by the SDP, synchronization with the DCF issuer;
receiving, by the SDP, an acceptance of the synchronization request from the DCF issuer;
sending, by the SDP, the last synchronization time and offloading transaction history to the DCF issuer;
receiving, by the SDP, confirmation from the DCF issuer of successful offload of the transaction history;
receiving, by the SDP, instructions from the DCF issuer to update the first ledger;
applying, by the SDP, the instructions received from the DCF issuer.

18. The method of claim 17, wherein the DCF are configured as Digital Copy-protected Files for Currencies (DCF-C) for use in financial transactions comprising micro-transactions.

19. The method of claim 18, wherein the Digital Copy-protected Files for Currencies (DCF-C) include a file format with the extension .dcf, and the format includes Header, Cryptographic Section, Value Section, Local Transaction Ledger (Transaction Entries), and Metadata.

20. The method of claim 17, wherein an isolated storage memory is configured to implement security measures on stored DCFs within the SDP, including at least one of:
digital signatures;
periodic validation;
dedicated storage requirements; and
mandatory Know Your Customer (KYC) or Know Your Business (KYB) procedures to unlock and use the SE.
